(19) United States
(12) Patent Application Publication
(10) Pub. No.: US 2026/0316031 A1
(43) Pub. Date: Oct. 15, 2026

(54) Cold Hydrogenation Production System and Production Process

(71) Applicant: Jiangsu Sunpower Heat Exchanger & Pressure Vessel Co., LTD., Nanjing (CN)

(72) Inventors: Hongxin Guo, Nanjing (CN); Haiwei Guo, Nanjing (CN); Jun Jiang, Nanjing (CN); Fang Wang, Nanjing (CN); Yang Zhao, Nanjing (CN); Jianjun Guo, Nanjing (CN); Bingcheng Zhu, Nanjing (CN)

(21) Appl. No.: 19/480,227

(22) PCT Filed: Mar. 3, 2025
(86) PCT No.: PCT/CN2025/080188

§ 371 Date: Oct. 30, 2025

(30) Foreign Application Priority Data
Jan. 3, 2024 (CN) 202410004084.X

(51) Int. Cl. B01J 8/18; C01B 33/107

(52) U.S. Cl. CPC B01J 8/1836; C01B 33/10763; B01J 2208/00115; B01J 2208/00256

(57) ABSTRACT

Provided are a cold hydrogenation production system and production process. The cold hydrogenation production system includes a cold hydrogenation reaction apparatus, a first heat exchange apparatus, a gas-solid separation apparatus, a second heat exchange apparatus, and a third heat exchange apparatus connected in sequence. The production system and process can enhance the utilization rate of reactants and promote the reaction toward the formation of trichlorosilane, thereby increasing the single-pass conversion rate of silicon tetrachloride to trichlorosilane. Moreover, the reaction heat generated during the cold hydrogenation reaction process is used as a heat source for multi-stage heat recovery to recycle residual heat, achieving scientifically and rationally cascaded utilization of reaction residual heat. The production system and process feature excellent energy integration, significant energy conservation, and high utilization efficiency of residual heat.

This application claims priority to Chinese Patent Application No. 202410004084.X filed with the China National Intellectual Property Administration (CNIPA) on Jan. 3, 2024, the disclosure of which is incorporated herein by reference in its entirety.

### TECHNICAL FIELD

This application pertains to the technical field of polysilicon production, for example, relating to a cold hydrogenation production system and production process.

### BACKGROUND

Polysilicon, a primary raw material for manufacturing semiconductors and solar photovoltaic cells, is typically produced using the silane method or the improved Siemens method. In the polysilicon production process, approximately 25% of trichlorosilane is converted into polysilicon, and silicon tetrachloride is formed as a byproduct. Silicon tetrachloride decomposes into silicic acid and highly toxic hydrogen chloride gas upon contact with moist air, posing significant harm to human health and potentially causing a large-scale crop yield reduction or failure. Even with internationally advanced technology, nearly 4 tons of silicon tetrachloride is produced for every 1 ton of polysilicon manufactured. In recent years, with the rapid expansion of polysilicon production scale, large quantities of silicon tetrachloride are generated during the process of polysilicon production. To prevent environmental pollution, recycling and utilization of silicon tetrachloride are necessary.

The cold hydrogenation method is a primary approach in the industry for recycling and utilizing the reduction byproduct silicon tetrachloride and providing trichlorosilane, a raw material for polysilicon production. However, this method suffers from issues such as low reaction conversion rates and insufficient utilization of thermal energy.

### SUMMARY

This application provides a cold hydrogenation production system and production process that are capable of increasing the conversion rate of silicon tetrachloride, reducing the supplementary heat required by the reaction system, and lowering energy consumption.

This application provides a cold hydrogenation production system. The system includes a cold hydrogenation reaction apparatus, a first heat exchange apparatus, a gas-solid separation apparatus, a second heat exchange apparatus, and a third heat exchange apparatus connected in sequence. A material outlet of the cold hydrogenation reaction apparatus is connected to a hot medium inlet of the first heat exchange apparatus, a hot medium outlet of the first heat exchange apparatus is connected to a material inlet of the gas-solid separation apparatus, and a cold medium outlet of the first heat exchange apparatus is connected to the cold hydrogenation reaction apparatus. A gas outlet of the gas-solid separation apparatus is connected to a hot medium inlet of the second heat exchange apparatus, and a solid outlet of the gas-solid separation apparatus is connected to the cold hydrogenation reaction apparatus. A cold medium inlet of the second heat exchange apparatus is connected to a material outlet of a first mixing apparatus, a cold medium outlet of the second heat exchange apparatus is connected to a second mixing apparatus, and a material outlet of the second mixing apparatus is connected to a cold medium inlet of the first heat exchange apparatus. A hot medium outlet of the second heat exchange apparatus is connected to a hot medium inlet of the third heat exchange apparatus, a cold medium inlet of the third heat exchange apparatus is connected to a material outlet of a silicon tetrachloride storage apparatus, a cold medium outlet of the third heat exchange apparatus is connected to a material inlet of a heating apparatus, and a material outlet of the heating apparatus is connected to an inlet of the second mixing apparatus.

In one or more embodiments, the cold hydrogenation production system also includes at least one stage of heat recovery apparatus. The heat recovery apparatus includes at least one of an absorption refrigeration apparatus, an organic Rankine cycle apparatus, or a space heating apparatus, where the heat recovery apparatus is connected to a hot medium outlet of the third heat exchange apparatus.

In one or more embodiments, a scrubbing apparatus is disposed between the heat recovery apparatus and the third heat exchange apparatus.

In one or more embodiments, a material outlet of a final-stage heat recovery apparatus is connected to a material inlet of a gas-liquid separation apparatus, a gas outlet of the gas-liquid separation apparatus is connected to the first mixing apparatus via a first gas recovery pipeline, and a liquid outlet of the gas-liquid separation apparatus is connected to a scrubbing liquid inlet of the scrubbing apparatus.

In one or more embodiments, a material inlet of the cold hydrogenation reaction apparatus is connected to a silicon powder feed pipeline and a catalyst feed pipeline, and a material inlet of the first mixing apparatus is connected to a hydrogen chloride storage apparatus and a hydrogen storage apparatus.

In one or more embodiments, a chlorosilane liquid discharge pipeline is drawn from an outlet of the gas-liquid separation apparatus, the chlorosilane liquid discharge pipeline and a chlorosilane scrubbing liquid pipeline from an outlet of the scrubbing apparatus are connected to a hot medium inlet of a fourth heat exchange apparatus, a hot medium outlet of the fourth heat exchange apparatus is connected to an inlet of a first condenser, and chilled water circulates between the absorption refrigeration apparatus and the fourth heat exchange apparatus via a chilled water circulation pipeline. Additionally, a gas outlet of the first condenser is connected to the first mixing apparatus via a second gas recovery pipeline, and a liquid outlet of the first condenser is connected to a distillation unit pipeline.

This application also provides a cold hydrogenation production process. The production process includes the following: mixing hydrogen chloride, hydrogen, and chlorosilane, and performing a first preheating on a mixture of the hydrogen chloride, the hydrogen, and the chlorosilane; performing a second preheating on silicon tetrachloride, and gasifying silicon tetrachloride after the second preheating; performing a third preheating on a mixture of gasified silicon tetrachloride and the mixture of the hydrogen chloride, the hydrogen, and the chlorosilane after the first preheating, and conducting a cold hydrogenation reaction on the mixture after the third preheating to obtain a gas-solid mixture; and after the gas-solid mixture is used as a heat source for the third preheating, performing gas-solid separation on the gas-solid mixture, returning an obtained solid to the cold hydrogenation reaction, and using an obtained gas as a heat source for the first preheating and the second preheating sequentially.

In one or more embodiments, the gas after the second preheating is scrubbed, and the scrubbed gas is used for heat recovery, where the heat recovery includes at least one of absorption refrigeration, organic Rankine cycle, or heating.

In one or more embodiments, gas-liquid separation is performed on a gas-liquid mixture after heat recovery, the obtained gas is mixed with the hydrogen chloride, the hydrogen, and the chlorosilane, the first preheating is performed on a mixture of the obtained gas, the hydrogen chloride, the hydrogen, and the chlorosilane, and the obtained liquid is used for the scrubbing.

### BRIEF DESCRIPTION OF DRAWINGS

FIG. 1 is a diagram of a cold hydrogenation production system according to an embodiment of this application.

FIG. 2 is a diagram of a fourth heat exchange apparatus in a cold hydrogenation production system according to an embodiment of this application.

FIG. 3 is a diagram of an absorption refrigeration apparatus in a cold hydrogenation production system according to an embodiment of this application.

### REFERENCE LIST

1 silicon powder feed pipeline
2 catalyst feed pipeline
3 cold hydrogenation reaction apparatus
4 first heat exchange apparatus
5 gas-solid separation apparatus
6 second heat exchange apparatus
7 first mixing apparatus
8 hydrogen chloride storage apparatus
9 hydrogen storage apparatus
10 third heat exchange apparatus
11 silicon tetrachloride storage apparatus
12 heating apparatus
13 second mixing apparatus
14 scrubbing apparatus
15 chlorosilane scrubbing liquid discharge pipeline
16 slurry discharge pipeline
17 absorption refrigeration apparatus
18 chilled water circulation pipeline
19 chilled water pipeline
20 first heating supply pipeline (from user)
21 first heating return pipeline (to user)
22 organic Rankine cycle apparatus
23 power generation apparatus
24 space heating apparatus
25 second heating supply pipeline (from user)
26 second heating return pipeline (to user)
27 gas-liquid separation apparatus
28 chlorosilane scrubbing liquid pipeline
29 chlorosilane liquid discharge pipeline
30 first gas recovery pipeline
31 fourth heat exchange apparatus
32 first condenser
33 second gas recovery pipeline
34 distillation unit pipeline
171 generator
172 second condenser
173 evaporator
174 absorber
175 fifth heat exchange apparatus

### DETAILED DESCRIPTION

The technical solutions of this application are described hereinafter through embodiments in conjunction with the drawings.

In the cold hydrogenation method, a catalyst, silicon powder, silicon tetrachloride, and hydrogen are introduced into a fluidized bed, generating trichlorosilane at a reaction temperature of 500-600 °C. The reaction equation is as follows: Si+3SiCl₄+2H₂=4SiHCl₃.

The above cold hydrogenation reaction is an endothermic process, requiring a significant amount of heat during the reaction. Currently, the reaction temperature is primarily maintained by electric heaters, leading to excessively high electricity consumption costs. Moreover, the waste of reaction residual heat results in energy loss, which does not align with national energy conservation and emission reduction requirements. Additionally, in actual production, the single-pass conversion rate of silicon tetrachloride is only 20-25%, a significant difference compared to laboratory single-pass conversion rates. Therefore, rational utilization of the heat generated during the reaction and improving the conversion rate of silicon tetrachloride to trichlorosilane are key to reducing production costs and expanding production scale for polysilicon enterprises.

An embodiment of this application provides a cold hydrogenation production system. The system utilizes the residual heat of cold hydrogenation reaction products through cascaded heat exchange and recycles hydrogen chloride, hydrogen, and other materials, thereby conserving resources and improving the utilization rate of reactants.

The system includes a cold hydrogenation reaction apparatus 3, a first heat exchange apparatus 4, a gas-solid separation apparatus 5, a second heat exchange apparatus 6, and a third heat exchange apparatus 10 connected in sequence.

A material outlet of the cold hydrogenation reaction apparatus 3 is connected to a hot medium inlet of the first heat exchange apparatus 4, a hot medium outlet of the first heat exchange apparatus 4 is connected to a material inlet of the gas-solid separation apparatus 5, and a cold medium outlet of the first heat exchange apparatus 4 is connected to the cold hydrogenation reaction apparatus 3.

A gas outlet of the gas-solid separation apparatus 5 is connected to a hot medium inlet of the second heat exchange apparatus 6, and a solid outlet of the gas-solid separation apparatus 5 is connected to the cold hydrogenation reaction apparatus 3.

A cold medium inlet of the second heat exchange apparatus 6 is connected to a material outlet of a first mixing apparatus 7, a cold medium outlet of the second heat exchange apparatus 6 is connected to a second mixing apparatus 13, and a material outlet of the second mixing apparatus 13 is connected to a cold medium inlet of the first heat exchange apparatus 4.

A hot medium outlet of the second heat exchange apparatus 6 is connected to a hot medium inlet of the third heat exchange apparatus 10, a cold medium inlet of the third heat exchange apparatus 10 is connected to a material outlet of a silicon tetrachloride storage apparatus 11, a cold medium outlet of the third heat exchange apparatus 10 is connected to a material inlet of a heating apparatus 12, and a material outlet of the heating apparatus 12 is connected to an inlet of the second mixing apparatus 13.

In this application, the cold hydrogenation production system utilizes the settings of the first heat exchange apparatus 4, the second heat exchange apparatus 6, and the third heat exchange apparatus 10 to sufficiently preheat raw materials of the cold hydrogenation reaction, such as hydrogen chloride, hydrogen, chlorosilane, and silicon tetrachloride, by using the gas-solid mixture generated after the reaction in the cold hydrogenation reaction apparatus 3 and the mixed gas obtained after separation. This fully utilizes the temperature of the gas-phase products, reduces the supplementary heat required by the reaction system, and lowers energy consumption. Additionally, after gas-solid separation, silicon powder particles entrained in the separated products are recycled, which reduces silicon loss and improves reaction efficiency.

Based on the above technical solution, the cold hydrogenation production system of this application can utilize the heat in the gas-phase mixture produced by the cold hydrogenation reaction as a heat source for multi-stage heating of silicon tetrachloride, hydrogen, hydrogen chloride, and recovered gas, which fully utilizes the temperature of the gas-phase products, reduces the supplementary heat required by the reaction system, and lowers energy consumption. Moreover, silicon powder particles in the gas-phase products after the reaction are recycled, reducing silicon loss. Additionally, hydrogen chloride is used as a reactant in the cold hydrogenation reaction. This synthesis reaction is an exothermic reaction, generating significant heat, autonomously increasing the temperature inside the cold hydrogenation reaction apparatus, and reducing external electric heating, thereby reducing energy consumption.

The cold hydrogenation production system also includes at least one stage of heat recovery apparatus. The heat recovery apparatus includes at least one of an absorption refrigeration apparatus 17, an organic Rankine cycle apparatus 22, and a space heating apparatus 24, where the heat recovery apparatus is connected to a hot medium outlet of the third heat exchange apparatus 10.

Based on the above technical solution, this application can utilize medium-and low-grade heat as a heat source for an absorption refrigeration system, an organic Rankine cycle system, or a space heating device, scientifically and rationally achieving cascaded energy utilization and enabling the output of diversified energy products such as heat, cold, electricity, and heating.

A scrubbing apparatus 14 is disposed between the heat recovery apparatus and the third heat exchange apparatus 10.

A material outlet of the final-stage heat recovery apparatus is connected to a material inlet of a gas-liquid separation apparatus 27, a gas outlet of the gas-liquid separation apparatus 27 is connected to the first mixing apparatus 7 via a first gas recovery pipeline 30, and a liquid outlet of the gas-liquid separation apparatus 27 is connected to a scrubbing liquid inlet of the scrubbing apparatus 14.

Based on the above technical solution, separating gas products for reuse through the gas-liquid separation apparatus facilitates resource conservation and improves the utilization rate of reactants. Additionally, excess hydrogen facilitates the reaction toward the formation of trichlorosilane and enhances the yield of trichlorosilane and the recycling of silicon tetrachloride.

A chlorosilane liquid discharge pipeline 29 is drawn from an outlet of the gas-liquid separation apparatus 27. The chlorosilane liquid discharge pipeline 29 and a chlorosilane scrubbing liquid pipeline from an outlet of the scrubbing apparatus 14 are connected to a hot medium inlet of a fourth heat exchange apparatus 31. A hot medium outlet of the fourth heat exchange apparatus 31 is connected to an inlet of a first condenser 32. Chilled water circulates between the absorption refrigeration apparatus 17 and the fourth heat exchange apparatus 31 via a chilled water circulation pipeline 18. Additionally, a gas outlet of the first condenser 32 is connected to the first mixing apparatus 7 via a second gas recovery pipeline 33, and a liquid outlet of the first condenser 32 is connected to a distillation unit pipeline 34. The chlorosilane liquid discharge pipeline 29 and the chlorosilane scrubbing liquid pipeline 28 from the outlet of the scrubbing apparatus 14 are connected to a hot medium inlet of the fourth heat exchange apparatus 31.

Chilled water discharged from an outlet of the absorption refrigeration apparatus enters a cold medium inlet of the fourth heat exchange apparatus, undergoes heat exchange, and returns to an inlet of the absorption refrigeration apparatus from a cold medium outlet of the fourth heat exchange apparatus.

Based on the above technical solution, this application uses chilled water produced by the absorption refrigeration apparatus as a cold source to cool the product chlorosilane through heat exchange, reducing energy consumption and improving the utilization rate of energy. Unreacted hydrogen chloride, hydrogen, and other gases are recycled, conserving resources and improving the utilization rate of reactants. Additionally, excess hydrogen facilitates the reaction toward the formation of trichlorosilane and enhances the yield of trichlorosilane and the recycling of silicon tetrachloride.

In an embodiment of this application, the heat recovery apparatus may include an absorption refrigeration apparatus 17, an organic Rankine cycle apparatus 22, and a space heating apparatus 24 connected in sequence.

In an embodiment of this application, a cold medium inlet of the absorption refrigeration apparatus 17 is connected to a chilled water circulation pipeline 18 and a first heating supply pipeline (from user) 20, and a cold medium outlet of the absorption refrigeration apparatus 17 is connected to a chilled water pipeline 19 and a first heating return pipeline (to user) 21.

In an embodiment of this application, the absorption refrigeration apparatus 17 may use lithium bromide and water as working media, where water is the refrigerant, and the lithium bromide aqueous solution is the absorbent.

In an embodiment of this application, the absorption refrigeration apparatus 17 includes a generator 171, a second condenser 172, an evaporator 173, an absorber 174, and a fifth heat exchange apparatus 175. A hot medium inlet of the generator 171 is connected to the scrubbing apparatus 14 to receive the gas-phase mixture from the scrubbing apparatus 14. A hot medium outlet of the generator 171 is connected to the organic Rankine cycle apparatus 22, a water vapor outlet of the generator 171 is connected to a water vapor inlet of the second condenser 172, and a water solution outlet of the generator 171 is connected to the fifth heat exchange apparatus 175. A medium-temperature water outlet of the second condenser 172 is connected to a medium-temperature water inlet of the evaporator 173, a water vapor outlet of the evaporator 173 is connected to the absorber 174, a chilled water outlet of the evaporator 173 is connected to the fourth heat exchange apparatus 31, and a chilled water circulation inlet of the evaporator 173 is connected to the fourth heat exchange apparatus 31. A water solution outlet of the absorber 174 is connected to the fifth heat exchange apparatus 175. A cooling water inlet of the absorber 174 receives heating supply water from the user. A cooling water outlet of the absorber 174 is connected to the second condenser 172 to introduce the heating supply water from the absorber 174 into the second condenser 172. A heating water outlet of the second condenser 172 is connected to the user to provide heating return water to the user.

The generator 171 receives a medium-temperature gas-phase mixture from the scrubbing apparatus 14, and the working medium solution in the generator 171 is heated by the medium-temperature gas-phase mixture, where water is vaporized into water vapor and enters the second condenser 172, condensing into water. The lithium bromide aqueous solution remaining in the generator 171 increases in concentration and enters the absorber 174 through the fifth heat exchange apparatus 175. The water condensed in the second condenser 172 enters the evaporator 173 and rapidly expands, vaporizing into water vapor. The water vapor enters the absorber 174 and is absorbed by the lithium bromide aqueous solution in the absorber 174, forming a low-concentration lithium bromide aqueous solution. The low-concentration lithium bromide aqueous solution enters the generator 171 after passing through the fifth heat exchange apparatus 175, completing the absorption refrigeration cycle. The heating supply water from the user enters the absorber 174, undergoes heat exchange with the low-concentration lithium bromide aqueous solution, increases in temperature, and then enters the second condenser 172 for heat exchange with the water vapor from the generator 171, further increases in temperature, forms hot water, and is connected to the user to provide heating return water. The chilled circulation water of the fourth heat exchange apparatus 31 enters the evaporator 173, where the medium-temperature water in the evaporator 173 rapidly expands and vaporizes into water vapor, absorbing a large amount of heat from the chilled circulation water and lowering the temperature of the chilled circulation water. The chilled water with reduced temperature enters the fourth heat exchange apparatus 31 to exchange heat with the chlorosilane from the scrubbing apparatus 14 and the gas-liquid separation apparatus 27, thereby reducing the temperature of the chlorosilane. After passing through the generator 171, the medium-temperature gas-phase mixture decreases in temperature, becomes a low-temperature gas-liquid mixture, is discharged from a gas-liquid outlet of the generator 171, and enters the organic Rankine cycle apparatus 22. The lithium bromide aqueous solution from the generator 171 and the lithium bromide aqueous solution from the absorber 174 undergo heat exchange through the fifth heat exchange apparatus 175.

In an embodiment of this application, the organic Rankine cycle apparatus 22 is connected to a power generation apparatus 23.

In an embodiment of this application, a cold medium inlet of the space heating apparatus 24 is connected to a second heating supply pipeline (from user) 25, and a cold medium outlet of the space heating apparatus 24 is connected to a second heating return pipeline (to user) 26.

In this application, the hot medium of the third heat exchange apparatus 10, that is, the mixed gas after preheating silicon tetrachloride, is scrubbed and further subjected to heat recovery. In other words, residual heat is recovered through the absorption refrigeration apparatus 17, the organic Rankine cycle apparatus 22, and the space heating apparatus 24, scientifically and rationally achieving cascaded energy utilization and completing the output of diversified energy products such as heat, cold, electricity, and heating.

An embodiment of this application provides a cold hydrogenation production process using the above cold hydrogenation production system. The production process includes the following:

Hydrogen chloride, hydrogen, and chlorosilane are mixed, and a first preheating is performed on a mixture of the hydrogen chloride, the hydrogen, and the chlorosilane.

A second preheating is performed on silicon tetrachloride, and silicon tetrachloride after the second preheating is heated.

A third preheating is performed on a mixture of gasified silicon tetrachloride and the mixture of the hydrogen chloride, the hydrogen, and the chlorosilane after the first preheating, and a cold hydrogenation reaction is conducted to obtain a gas-solid mixture.

After the gas-solid mixture is used for the third preheating, gas-solid separation is performed on the gas-solid mixture. The obtained solid is returned to the cold hydrogenation reaction, and the obtained gas is sequentially used for the first preheating and the second preheating.

The cold hydrogenation production process also includes scrubbing the gas after the third preheating and using the scrubbed gas for heat recovery, where the heat recovery includes at least one of absorption refrigeration, organic Rankine cycle, or heating.

The production process also includes scrubbing the gas after the second preheating and using the scrubbed gas for heat recovery, where the heat recovery includes at least one of absorption refrigeration, organic Rankine cycle, or heating.

The cold hydrogenation production process also includes performing gas-liquid separation on a gas-liquid mixture after heat recovery, mixing the obtained gas with the hydrogen chloride, the hydrogen, and the chlorosilane, and performing the first preheating on a mixture of the obtained gas, the hydrogen chloride, the hydrogen, and the chlorosilane; reusing the obtained liquid for the scrubbing.

In an embodiment of this application, the cold hydrogenation reaction is 2SiCl₄+H₂+Si+HCl→3SiHCl₃. Compared to the trichlorosilane synthesis method without hydrogen chloride, this synthesis method has a lower reaction temperature and is an exothermic reaction, which can reduce the energy consumption for synthesizing trichlorosilane in this application.

In an embodiment of this application, the cold hydrogenation reaction temperature is 500-600 °C, and the reaction pressure is 2.5-3.8 MPa. The reaction temperature may be 500 °C, 510 °C, 520 °C, 530 °C, 540 °C, 550 °C, 560 °C, 570 °C, 580 °C, 590 °C, or 600 °C, and the reaction pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the temperature of the hydrogen chloride, hydrogen, and chlorosilane (recovered gas may also be included) after the first preheating may be 240-270 °C, with a pressure of 2.5-3.8 MPa. The temperature may be 240 °C, 245 °C, 250 °C, 255 °C, 260 °C, 265 °C, or 270 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the temperature of the silicon tetrachloride after the second preheating and heating is 240-270 °C, with a pressure of 2.5-3.8 MPa. The temperature may be 240 °C, 245 °C, 250 °C, 255 °C, 260 °C, 265 °C, or 270 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the temperature of the mixed gas of hydrogen chloride, hydrogen, and silicon tetrachloride (recovered gas may also be included) after the third preheating is 390-420 °C, with a pressure of 2.5-3.8 MPa. The temperature may be 390 °C, 395 °C, 400 °C, 405 °C, 410 °C, 415 °C, or 420 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the temperature of the gas-solid mixture produced by the cold hydrogenation reaction after the third preheating is 440-480 °C, with a pressure of 2.5-3.8 MPa. The temperature may be 440 °C, 445 °C, 450 °C, 455 °C, 460 °C, 465 °C, 470 °C, 475 °C, or 480 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the temperature of the mixed gas after gas-solid separation is 400-440 °C, with a pressure of 2.5-3.8 MPa. The temperature may be 400 °C, 405 °C, 410 °C, 415 °C, 420 °C, 425 °C, 430 °C, 435 °C, or 440 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the temperature of the mixed gas after the first preheating is 300-340 °C, with a pressure of 2.5-3.8 MPa. The temperature may be 300 °C, 305 °C, 310 °C, 315 °C, 320 °C, 325 °C, 330 °C, 335 °C, or 340 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the temperature of the mixed gas after the second preheating is 220-260 °C, with a pressure of 2.5-3.8 MPa. The temperature may be 220 °C, 225 °C, 230 °C, 235 °C, 240 °C, 245 °C, 250 °C, 255 °C, or 260 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the temperature of the gas mixture after being scrubbed by the scrubbing apparatus 14 is 190-230 °C, with a pressure of 2.5-3.8 MPa. The temperature may be 190 °C, 195 °C, 200 °C, 205 °C, 210 °C, 215 °C, 220 °C, 225 °C, or 230 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the temperature of the gas-liquid mixture after passing through the absorption refrigeration apparatus 17 is 140-180 °C, with a pressure of 2.5-3.8 MPa. The temperature may be 140 °C, 145 °C, 150 °C, 155 °C, 160 °C, 165 °C, 170 °C, 175 °C, or 180 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the temperature of the gas-liquid mixture after passing through the organic Rankine cycle apparatus 22 is 90-130 °C, with a pressure of 2.5-3.8 MPa. The temperature may be 90 °C, 95 °C, 100 °C, 105 °C, 110 °C, 115 °C, 120 °C, 125 °C, or 130 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the temperature of the gas-liquid mixture after passing through the space heating apparatus 24 is 50-90 °C, with a pressure of 2.5-3.8 MPa. The temperature may be 50 °C, 55 °C, 60 °C, 65 °C, 70 °C, 75 °C, 80 °C, 85 °C, or 90 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, a portion of the gas-liquid mixture after gas-liquid separation is returned to the scrubbing apparatus 14, and a portion enters the fourth heat exchange apparatus 31. The temperature of the liquid entering the fourth heat exchange apparatus 31 is 50-90 °C, with a pressure of 2.5-3.8 MPa. The temperature may be 50 °C, 55 °C, 60 °C, 65 °C, 70 °C, 75 °C, 80 °C, 85 °C, or 90 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the scrubbing liquid and a portion of the liquid after gas-liquid separation undergo heat exchange with chilled water produced by the absorption refrigeration apparatus 17 in the fourth heat exchange apparatus 31, and the gas-liquid mixture at the outlet enters the first condenser 32 at a temperature of 20-60 °C, with a pressure of 2.5-3.8 MPa. The temperature may be 20 °C, 25 °C, 30 °C, 35 °C, 40 °C, 45 °C, 50 °C, 55 °C, or 60 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

In an embodiment of this application, the gas-liquid mixture after heat exchange in the fourth heat exchange apparatus 31 enters the first condenser 32. The temperature of the mixture at the outlet of the first condenser 32 is −20-20 °C, with a pressure of 2.5-3.8 MPa. The non-condensed gas phase enters the first gas recovery pipeline 30, and the condensed liquid phase enters the distillation unit pipeline 34. The temperature may be −20 °C, −15 °C, −5 °C, 0 °C, 5 °C, 10 °C, 15 °C, or 20 °C, and the pressure may be 2.5 MPa, 2.8 MPa, 3.0 MPa, 3.2 MPa, 3.5 MPa, or 3.8 MPa, but is not limited to the listed values. Other values within the above ranges are equally applicable.

To explain this application and facilitate the understanding of the technical solutions, embodiments of this application are provided below.

### Embodiment One

This embodiment provides a cold hydrogenation production system. The system includes a cold hydrogenation reaction apparatus 3, a first heat exchange apparatus 4, a gas-solid separation apparatus 5, a second heat exchange apparatus 6, and a third heat exchange apparatus 10 connected in sequence.

A material outlet of the cold hydrogenation reaction apparatus 3 is connected to a hot medium inlet of the first heat exchange apparatus 4, a hot medium outlet of the first heat exchange apparatus 4 is connected to a material inlet of the gas-solid separation apparatus 5, and a cold medium outlet of the first heat exchange apparatus 4 is connected to the cold hydrogenation reaction apparatus 3.

A gas outlet of the gas-solid separation apparatus 5 is connected to a hot medium inlet of the second heat exchange apparatus 6, and a solid outlet of the gas-solid separation apparatus 5 is connected to the cold hydrogenation reaction apparatus 3.

A cold medium inlet of the second heat exchange apparatus 6 is connected to a material outlet of a first mixing apparatus 7, a cold medium outlet of the second heat exchange apparatus 6 is connected to a second mixing apparatus 13, and a material outlet of the second mixing apparatus 13 is connected to a cold medium inlet of the first heat exchange apparatus 4.

A hot medium outlet of the second heat exchange apparatus 6 is connected to a hot medium inlet of the third heat exchange apparatus 10, a cold medium inlet of the third heat exchange apparatus 10 is connected to a material outlet of a silicon tetrachloride storage apparatus 11, a cold medium outlet of the third heat exchange apparatus 10 is connected to a material inlet of a heating apparatus 12, and a material outlet of the heating apparatus 12 is connected to an inlet of the second mixing apparatus 13.

### Embodiment Two

This embodiment provides a cold hydrogenation production system whose structure is shown in FIG. 1. The system includes a cold hydrogenation reaction apparatus 3, a first heat exchange apparatus 4, a gas-solid separation apparatus 5, a second heat exchange apparatus 6, and a third heat exchange apparatus 10 connected in sequence.

A material outlet of the cold hydrogenation reaction apparatus 3 is connected to a hot medium inlet of the first heat exchange apparatus 4. A hot medium outlet of the first heat exchange apparatus 4 is connected to a material inlet of the gas-solid separation apparatus 5, and a cold medium outlet of the first heat exchange apparatus 4 is connected to the cold hydrogenation reaction apparatus 3. A material inlet of the cold hydrogenation reaction apparatus 3 is connected to a silicon powder feed pipeline 1 and a catalyst feed pipeline 2.

A gas outlet of the gas-solid separation apparatus 5 is connected to a hot medium inlet of the second heat exchange apparatus 6, and a solid outlet of the gas-solid separation apparatus 5 is connected to the cold hydrogenation reaction apparatus 3.

A cold medium inlet of the second heat exchange apparatus 6 is connected to a material outlet of a first mixing apparatus 7, a cold medium outlet of the second heat exchange apparatus 6 is connected to a second mixing apparatus 13, and a material outlet of the second mixing apparatus 13 is connected to a cold medium inlet of the first heat exchange apparatus 4. A material inlet of the first mixing apparatus 7 is connected to a hydrogen chloride storage apparatus 8 and a hydrogen storage apparatus 9, and the material inlet of the first mixing apparatus 7 is also connected to a chlorosilane liquid discharge pipeline 29 and a first gas recovery pipeline 30.

A hot medium outlet of the second heat exchange apparatus 6 is connected to a hot medium inlet of the third heat exchange apparatus 10. A cold medium inlet of the third heat exchange apparatus 10 is connected to a material outlet of a silicon tetrachloride storage apparatus 11, and a cold medium outlet of the third heat exchange apparatus 10 is connected to a material inlet of a heating apparatus 12. A material outlet of the heating apparatus 12 is connected to the second mixing apparatus 13.

A scrubbing apparatus 14 and at least one stage of heat recovery apparatus are sequentially disposed between the third heat exchange apparatus 10 and the first gas recovery pipeline 30.

The heat recovery apparatus includes an absorption refrigeration apparatus 17, an organic Rankine cycle apparatus 22, and a space heating apparatus 24 connected in sequence. A hot medium outlet of the space heating apparatus 24 is connected to a material inlet of a gas-liquid separation apparatus 27. A gas outlet of the gas-liquid separation apparatus 27 is connected to the first gas recovery pipeline 30, and a liquid outlet of the gas-liquid separation apparatus 27 is connected to a scrubbing liquid inlet of the scrubbing apparatus 14.

The scrubbing apparatus 14 is connected to a chlorosilane scrubbing liquid discharge pipeline 15 and a slurry discharge pipeline 16. A cold medium inlet of the absorption refrigeration apparatus 17 is connected to a chilled water circulation pipeline 18 and a first heating supply pipeline (from user) 20, and a cold medium outlet of the absorption refrigeration apparatus 17 is connected to a chilled water pipeline 19 and a first heating return pipeline (to user) 21. The organic Rankine cycle apparatus 22 is connected to a power generation apparatus 23. A cold medium inlet of the space heating apparatus 24 is connected to a second heating supply pipeline (from user) 25, and a cold medium outlet of the space heating apparatus 24 is connected to a second heating return pipeline (to user) 26.

### Embodiment Three

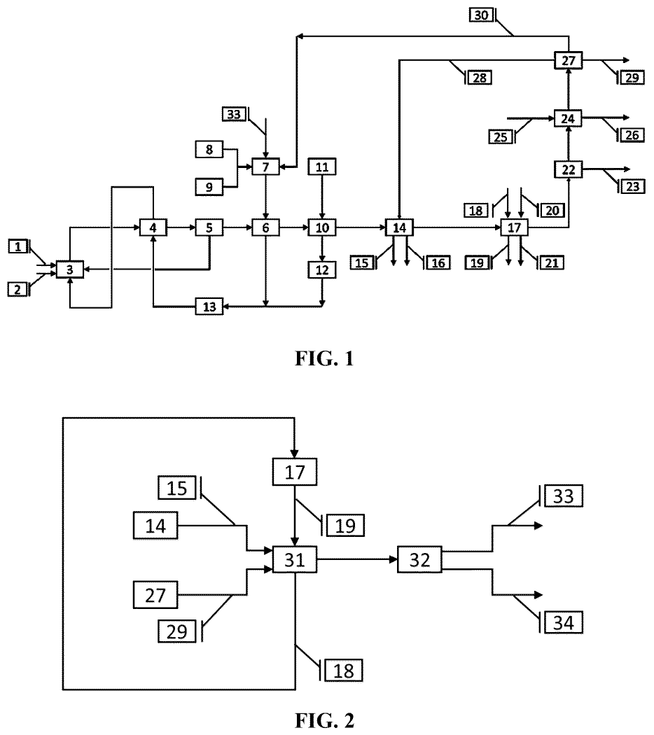

This embodiment provides a cold hydrogenation production system whose structure is identical to that in embodiment two except for the inclusion of a fourth heat exchange apparatus 31, as shown in FIG. 2.

A hot medium inlet of the fourth heat exchange apparatus 31 is connected to a chlorosilane scrubbing liquid discharge pipeline 15 of the scrubbing apparatus 14 and a chlorosilane liquid discharge pipeline 29 of the gas-liquid separation apparatus 27. A hot medium outlet of the fourth heat exchange apparatus 31 is connected to an inlet of a first condenser 32, a cold medium inlet of the fourth heat exchange apparatus 31 is connected to a chilled water pipeline 19 of the absorption refrigeration apparatus 17, and a cold medium outlet of the fourth heat exchange apparatus 31 is connected to a chilled water circulation pipeline 18 of the absorption refrigeration apparatus 17. A gas outlet of the first condenser 32 is connected to a second gas recovery pipeline 33 and a distillation unit pipeline 34.

### Embodiment Four

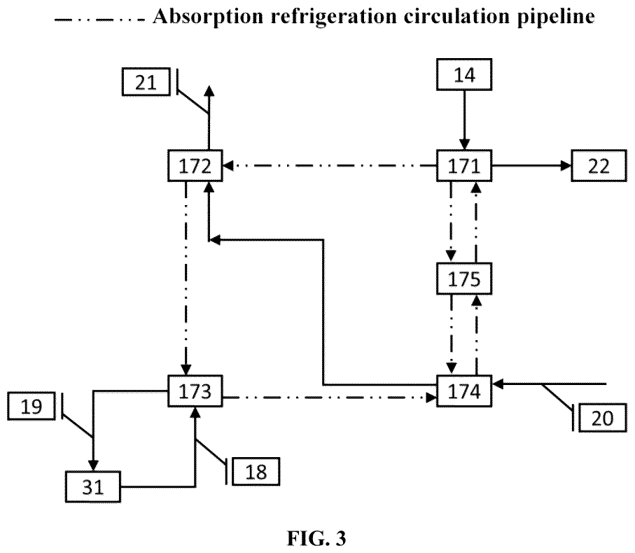

This embodiment provides a cold hydrogenation production system whose structure is identical to that in embodiment two except for the structure of the absorption refrigeration apparatus 17, as shown in FIG. 3.

The absorption refrigeration apparatus 17 includes a generator 171, a second condenser 172, an evaporator 173, an absorber 174, and a fifth heat exchange apparatus 175.

A hot medium inlet of the generator 171 is connected to the scrubbing apparatus 14. A hot medium outlet is connected to the organic Rankine cycle apparatus 22 to introduce the gas-liquid mixture into the organic Rankine cycle apparatus 22. A cold medium inlet is connected to the fifth heat exchange apparatus 175. A cold medium vapor outlet and a liquid outlet are connected to a hot medium inlet of the second condenser 172 and the fifth heat exchange apparatus 175, respectively.

A hot medium inlet of the second condenser 172 is connected to a cold medium outlet of the generator 171, a hot medium outlet is connected to a hot medium inlet of the evaporator 173, and a cold medium inlet is connected to the absorber 174.

A hot medium outlet of the evaporator 173 is connected to a hot medium inlet of the absorber 174. A cold medium inlet and a cold medium outlet are connected to the fourth heat exchange apparatus 31, forming a chilled water circulation.

A hot medium outlet of the absorber 174 is connected to the fifth heat exchange apparatus 175, and a cold medium outlet is connected to the second condenser 172.

The fifth heat exchange apparatus 175 is connected to the generator 171 and the absorber 174.

### Embodiment Five

This embodiment provides a cold hydrogenation production process using the cold hydrogenation production system provided in embodiment four. The production process includes the following steps:
(1) Hydrogen chloride, excess hydrogen, and recovered gas are mixed through a first mixing apparatus 7, and then a first preheating is performed on the hydrogen chloride, hydrogen, and recovered gas through a second heat exchange apparatus 6. The temperature of the mixture of hydrogen chloride, hydrogen, and recovered gas after preheating is 240-270 °C, and the pressure is 2.5-3.8 MPa.
(2) Liquid silicon tetrachloride is introduced into a third heat exchange apparatus 10 for a second preheating, and then the silicon tetrachloride is heated through a heating apparatus 12 until complete gasification is achieved. The temperature of the gasified silicon tetrachloride is 240-270 °C, and the pressure is 2.5-3.8 MPa.
(3) Hydrogen chloride, hydrogen, recovered gas, and gasified silicon tetrachloride are mixed through a second mixing apparatus 13, and then a third preheating is performed on the hydrogen chloride, hydrogen, recovered gas, and silicon tetrachloride through a first heat exchange apparatus 4. The temperature of the mixed gas of hydrogen chloride, hydrogen, recovered gas, and silicon tetrachloride after preheating is 390-420 °C, and the pressure is 2.5-3.8 MPa.
(4) The preheated mixed gas of hydrogen chloride, hydrogen, recovered gas, and silicon tetrachloride is introduced into a cold hydrogenation reaction apparatus 3 and mixed with a catalyst and excess silicon powder to undergo a cold hydrogenation reaction, with a reaction temperature of 530-580 °C and a pressure of 2.5-3.8 MPa. The reaction product is a gas-phase mixture and mainly includes dichlorosilane, trichlorosilane, hydrogen, hydrogen chloride, silicon powder, and silicon tetrachloride. The main reaction of the cold hydrogenation reaction is 2SiCl₄+H₂+Si+HCl→3SiHCl₃, with a single-pass yield of trichlorosilane of 32%.
(5) The gas-solid mixture generated in step (4) is introduced into the first heat exchange apparatus 4 to exchange heat with the mixed gas of hydrogen chloride, hydrogen, recovered gas, and silicon tetrachloride from step (3). The temperature of the gas-phase mixture after heat exchange is 440-480 °C, and the pressure is 2.5-3.8 MPa.
(6) The gas-solid mixture after heat exchange in step (5) is introduced into a gas-solid separation apparatus 5 for gas-solid separation, and the separated solid is discharged from the bottom of the gas-solid separation apparatus 5 and reintroduced into the cold hydrogenation reaction apparatus 3 for the cold hydrogenation reaction. The temperature of the separated gas-phase mixture is 400-440 °C, and the pressure is 2.5-3.8 MPa.
(7) The gas-phase mixture separated in step (6) is introduced into the second heat exchange apparatus 6 to exchange heat with the mixture of hydrogen chloride, hydrogen, and recovered gas from step (1). The temperature of the gas-phase mixture after heat exchange is 300-340 °C, and the pressure is 2.5-3.8 MPa.
(8) The gas-phase mixture after heat exchange in step (7) is introduced into the third heat exchange apparatus 10 to exchange heat with the liquid silicon tetrachloride from step (2). The temperature of the gas-phase mixture after heat exchange is 220-260 °C, and the pressure is 2.5-3.8 MPa.
(9) The gas-phase mixture after heat exchange in step (8) is introduced into a scrubbing apparatus 14, the scrubbing liquid is recovered into a fourth heat exchange apparatus 31, and the slurry is discharged from the bottom of the scrubbing apparatus 14. The temperature of the gas-phase mixture at the outlet is 190-230 °C, and the pressure is 2.5-3.8 MPa.
(10) The gas-phase mixture from the scrubbing apparatus 14 in step (9) is introduced into an absorption refrigeration apparatus 17 for heat exchange, and the gas-phase mixture forms a gas-liquid mixture after heat exchange and cooling. The outlet temperature is 140-180 °C, and the pressure is 2.5-3.8 MPa. Simultaneously, the absorption refrigeration apparatus 17 produces chilled water and heating water.
(11) The gas-liquid mixture from the absorption refrigeration apparatus 17 in step (10) is introduced into an organic Rankine cycle apparatus 22, and the residual heat of the gas-liquid mixture is utilized for power generation. The temperature of the gas-liquid mixture at the outlet is 90-130 °C, and the pressure is 2.5-3.8 MPa.
(12) The gas-liquid mixture from the organic Rankine cycle apparatus 22 in step (11) is introduced into a space heating apparatus 24, and the residual heat of the gas-liquid mixture is utilized for heating. The temperature of the gas-liquid mixture at the outlet is 50-90 °C, and the pressure is 2.5-3.8 MPa.
(13) The gas-liquid mixture from the space heating apparatus 24 in step (12) is introduced into a gas-liquid separation apparatus 27, the gas is recovered into the first mixing apparatus 7, and the liquid partially enters the scrubbing apparatus 14 and partially enters the fourth heat exchange apparatus 31. The temperature of the liquid entering the fourth heat exchange apparatus 31 is 50-90 °C, and the pressure is 2.5-3.8 MPa.
(14) The scrubbing liquid from step (9) and the liquid from step (13) are introduced into the fourth heat exchange apparatus 31 to exchange heat with chilled water produced by the absorption refrigeration apparatus 17 in step (10). The gas-liquid mixture at the outlet entering a first condenser 32 is at a temperature of 20-60 °C and with a pressure of 2.5-3.8 MPa.

The gas-liquid mixture from the fourth heat exchange apparatus 31 in step (14) is introduced into the first condenser 32. The temperature of the mixture at the outlet of the first condenser 32 is −20-20 °C, and the pressure is 2.5-3.8 MPa. The non-condensed gas phase enters a first gas recovery pipeline 30, and the condensed liquid phase enters a distillation unit pipeline 34.

The cold hydrogenation production system in the embodiments recycles silicon powder particles in the gas-phase products after the reaction, reducing silicon loss. The system uses hydrogen chloride as a reactant in the cold hydrogenation reaction. This synthesis reaction is an exothermic reaction, generating significant heat, autonomously increasing the temperature inside the cold hydrogenation reaction apparatus, and reducing external electric heating, thereby reducing energy consumption. The system utilizes the heat in the gas-phase mixture produced by the cold hydrogenation reaction as a heat source for multi-stage heating of silicon tetrachloride, hydrogen, hydrogen chloride, and recovered gas, which fully utilizes the temperature of the gas-phase products, reduces the supplementary heat required by the reaction system, and lowers energy consumption. The system utilizes medium-and low-grade heat as a heat source for the absorption refrigeration apparatus, organic Rankine cycle apparatus, and space heating apparatus, scientifically and rationally achieving cascaded energy utilization and completing the output of diversified energy products such as heat, cold, electricity, and heating. The system uses chilled water produced by the absorption refrigeration apparatus as a cold source to cool the product chlorosilane through heat exchange, reducing energy consumption and improving the utilization rate of energy. Unreacted hydrogen chloride, hydrogen, and other gases are recycled, conserving resources and improving the utilization rate of reactants. Additionally, excess hydrogen facilitates the reaction toward the formation of trichlorosilane and enhances the yield of trichlorosilane and the recycling of silicon tetrachloride.

This application has the following effects:
(1) This application provides a cold hydrogenation production system and production process that are capable of recycling silicon powder particles entrained in the gas-phase products after the reaction, reducing silicon loss and improving reaction efficiency.
(2) This application provides a cold hydrogenation production system and production process that use high-purity hydrogen chloride gas as a reactant in the cold hydrogenation reaction. This synthesis reaction is an exothermic reaction, generating significant heat, autonomously increasing the temperature inside the reaction apparatus, and reducing external electric heating, thereby reducing energy consumption. Additionally, the addition of hydrogen chloride increases the conversion rate of silicon tetrachloride to trichlorosilane.
(3) This application provides a cold hydrogenation production system and production process that utilize the heat in the gas-phase mixture produced by the cold hydrogenation reaction as a heat source for multi-stage heating of hydrogen, hydrogen chloride, recovered gas, and silicon tetrachloride, which fully utilizes the temperature of the gas-phase products, reduces the supplementary heat required by the reaction system, and lowers energy consumption.
(4) This application provides a cold hydrogenation production system and production process that achieve cascaded energy utilization, use the gas-phase mixture produced by the cold hydrogenation reaction as a high-temperature heat source for multi-stage heat exchange with hydrogen, hydrogen chloride, recovered gas, and silicon tetrachloride, and then as a medium-and low-temperature heat source for residual heat recovery sequentially through an absorption refrigeration apparatus (for refrigeration and heating), an organic Rankine cycle apparatus for power generation, and a space heating device. Thus, cascaded energy utilization is scientifically and rationally achieved, and the output of diversified energy products such as heat, cold, electricity, and heating is completed.
(5) This application provides a cold hydrogenation production system and production process that use chilled water produced by absorption refrigeration as a cold source to cool the mixture of hydrogen, hydrogen chloride, and chlorosilane through heat exchange, reducing energy consumption and improving the utilization rate of energy.
(6) This application provides a cold hydrogenation production system and production process that are capable of recycling hydrogen chloride, hydrogen, and non-liquefied chlorosilane gas, conserving resources and improving the utilization rate of reactants.

The above describes optional embodiments of this application. However, this application is not limited to the details in the above embodiments. Within the technical concept of this application, various simple modifications may be made to the technical solutions of this application, and these simple modifications fall within the scope of this application.

Multiple technical features described in the above embodiments may be combined in any suitable manner without contradiction. To avoid unnecessary repetition, this application does not further describe various possible combinations.

Moreover, various embodiments of this application may be arbitrarily combined, as long as they do not contradict the concept of this application, and such combinations should also be considered as disclosed content of this application.

What is claimed is:

1. A cold hydrogenation production system, comprising: a cold hydrogenation reaction apparatus, a first heat exchange apparatus, a gas-solid separation apparatus, a second heat exchange apparatus, and a third heat exchange apparatus connected in sequence; wherein
a material outlet of the cold hydrogenation reaction apparatus is connected to a hot medium inlet of the first heat exchange apparatus, a hot medium outlet of the first heat exchange apparatus is connected to a material inlet of the gas-solid separation apparatus, and a cold medium outlet of the first heat exchange apparatus is connected to the cold hydrogenation reaction apparatus;
a gas outlet of the gas-solid separation apparatus is connected to a hot medium inlet of the second heat exchange apparatus, and a solid outlet of the gas-solid separation apparatus is connected to the cold hydrogenation reaction apparatus;
a cold medium inlet of the second heat exchange apparatus is connected to a material outlet of a first mixing apparatus, a cold medium outlet of the second heat exchange apparatus is connected to a second mixing apparatus, and a material outlet of the second mixing apparatus is connected to a cold medium inlet of the first heat exchange apparatus; and
a hot medium outlet of the second heat exchange apparatus is connected to a hot medium inlet of the third heat exchange apparatus, a cold medium inlet of the third heat exchange apparatus is connected to a material outlet of a silicon tetrachloride storage apparatus, a cold medium outlet of the third heat exchange apparatus is connected to a material inlet of a heating apparatus, and a material outlet of the heating apparatus is connected to an inlet of the second mixing apparatus.

2. The cold hydrogenation production system according to claim 1, further comprising: at least one stage of heat recovery apparatus, wherein the heat recovery apparatus comprises at least one of an absorption refrigeration apparatus, an organic Rankine cycle apparatus, or a space heating apparatus; and
the heat recovery apparatus is connected to a hot medium outlet of the third heat exchange apparatus.

3. The cold hydrogenation production system according to claim 2, wherein a scrubbing apparatus is disposed between the heat recovery apparatus and the third heat exchange apparatus.

4. The cold hydrogenation production system according to claim 3, wherein a material outlet of a final-stage heat recovery apparatus of the at least one stage of heat recovery apparatus is connected to a material inlet of a gas-liquid separation apparatus, a gas outlet of the gas-liquid separation apparatus is connected to the first mixing apparatus via a first gas recovery pipeline, and a liquid outlet of the gas-liquid separation apparatus is connected to a scrubbing liquid inlet of the scrubbing apparatus.

5. The cold hydrogenation production system according to claim 1, wherein a material inlet of the cold hydrogenation reaction apparatus is connected to a silicon powder feed pipeline and a catalyst feed pipeline; and
a material inlet of the first mixing apparatus is connected to a hydrogen chloride storage apparatus and a hydrogen storage apparatus.

6. The cold hydrogenation production system according to claim 4, wherein a chlorosilane liquid discharge pipeline is drawn from an outlet of the gas-liquid separation apparatus, the chlorosilane liquid discharge pipeline and a chlorosilane scrubbing liquid pipeline from an outlet of the scrubbing apparatus are connected to a hot medium inlet of a fourth heat exchange apparatus, a hot medium outlet of the fourth heat exchange apparatus is connected to an inlet of a first condenser, and chilled water circulates between the absorption refrigeration apparatus and the fourth heat exchange apparatus via a chilled water circulation pipeline; and
a gas outlet of the first condenser is connected to the first mixing apparatus via a second gas recovery pipeline, and a liquid outlet of the first condenser is connected to a distillation unit pipeline.

7. The cold hydrogenation production system according to claim 2, wherein the absorption refrigeration apparatus comprises a generator, a second condenser, an evaporator, an absorber, and a fifth heat exchange apparatus.

8. A cold hydrogenation production process, comprising:
mixing hydrogen chloride, hydrogen, and chlorosilane, and performing a first preheating on a mixture of the hydrogen chloride, the hydrogen, and the chlorosilane;
performing a second preheating on silicon tetrachloride, and gasifying silicon tetrachloride after the second preheating;
performing a third preheating on a mixture of gasified silicon tetrachloride and the mixture of the hydrogen chloride, the hydrogen, and the chlorosilane after the first preheating, and conducting a cold hydrogenation reaction on the mixture after the third preheating to obtain a gas-solid mixture; and
after the gas-solid mixture is used as a heat source for the third preheating, performing gas-solid separation on the gas-solid mixture, returning an obtained solid to the cold hydrogenation reaction, and using an obtained gas as a heat source for the first preheating and the second preheating sequentially.

9. The cold hydrogenation production process according to claim 8, further comprising: scrubbing a gas after the second preheating, and using a scrubbed gas for heat recovery, wherein the heat recovery comprises at least one of absorption refrigeration, organic Rankine cycle, or heating.

10. The cold hydrogenation production process according to claim 9, further comprising: performing gas-liquid separation on a gas-liquid mixture after heat recovery, mixing an obtained gas with the hydrogen chloride, the hydrogen, and the chlorosilane, performing the first preheating on a mixture of the obtained gas, the hydrogen chloride, the hydrogen, and the chlorosilane, and reusing an obtained liquid for the scrubbing.

11. The cold hydrogenation production system according to claim 2, wherein a material inlet of the cold hydrogenation reaction apparatus is connected to a silicon powder feed pipeline and a catalyst feed pipeline; and
a material inlet of the first mixing apparatus is connected to a hydrogen chloride storage apparatus and a hydrogen storage apparatus.
